(19) United States
(12) Patent Application Publication
(10) Pub. No.: US 2005/0002848 A1
(43) Pub. Date: Jan. 6, 2005

(54) Preparation of particulate metal carbide

(76) Inventors: Hidetaka Konno, Sapporo-shi (JP); Mikio Aramata, Usui-gun (JP)

Correspondence Address: BIRCH STEWART KOLASCH & BIRCH, PO BOX 747, FALLS CHURCH, VA, 22040-0747, US

(21) Appl. No.: 10/880,541

(22) Filed: Jul. 1, 2004

(30) Foreign Application Priority Data
Jul. 4, 2003 (JP) 2003-192392

(51) Int. Cl. B05D 5/00; C01B 31/30

(52) U.S. Cl. 423/439; 427/212

(57) ABSTRACT

A metal carbide in microparticulate form is produced by causing an organometallic compound having a polymerizable reactive group to be sorbed to graphite, thermally stabilizing the organometallic compound into a substantially non-volatile polymer within the graphite through hydrolytic condensation, thermal polymerization or catalytic polymerization, and heat treating the polymer at a temperature of at least 1300° C. in a non-oxidizing atmosphere.

### TECHNICAL FIELD

This invention relates to a process for preparing particulate metal carbides useful as heat resistant materials, pyrogenic materials, structural materials, and abrasive or machining materials.

### BACKGROUND ART

Metal carbide powders have been used as cemented carbide materials in machining tools and abrasion resistant tools. They now find use as thermal spraying materials (Cr₃C₂, NbC, WC, etc.), electroconductive additives (TiC, etc.) to engineering ceramics, and thermal insulating materials (ZrC, etc.) utilizing infrared emission. Recent development efforts are directed to the advanced applications such as thermionic emission materials, catalysts and electromagnetic wave absorbers.

In the industry, metal carbides are generally produced by the following processes:
(1) high-temperature reaction of metal or metal oxide with carbon in vacuum or an inert atmosphere of hydrogen or the like, known as reductive carbonization,
(2) high-temperature reaction of metal or metal oxide with carbon in molten metal, known as direct reaction, and
(3) vapor phase reaction using metal halide, metal carbonyl or the like as the raw material, known as vapor phase synthesis.

The reductive carbonization process (1) or the direct reaction process (2), when starting with silicon powder, for example, results in a silicon carbide powder composed mainly of coarse particles. In order to use this silicon carbide powder as sintering material or in polishing application, it must be subjected to grinding and classifying steps requiring a considerable amount of labor. Since the metal carbide powder resulting from the grinding step still has a wide particle size distribution and contains more impurities introduced by the step, it is not regarded suitable in the intended application. For silicon carbide (SiC), the continuous synthesis of fine powder by process (1) is commonly used in the industry. However, since the product contains unreacted raw material, a chemical purifying step must be taken.

Only the vapor phase synthesis process (3) can produce fine particles of submicron size and of high purity. Because of an increased expense, however, the process is not acceptable for the synthesis of industrial powder materials.

None of the prior art processes have succeeded in producing particulate metal carbides having satisfactory chemical and physical properties. It would be desirable to have a simple, less expensive process for preparing particulate metal carbides having a wide range of application as high-function engineering materials.

The related technology is described in “Collection of Ceramic Material Technology,” April 1979, Sangyo Gijutsu Center K.K.

### SUMMARY OF THE INVENTION

An object of the invention is to provide a simple, less expensive process for preparing particulate metal carbides having a wide range of application as high-function engineering materials.

Surprisingly, we have found that by causing an organometallic compound, preferably having a polymerizable reactive group such as a hydrolyzable group, to be sorbed to graphite, thermally stabilizing the organometallic compound into a substantially non-volatile polymer within the graphite through thermal polymerization, catalytic polymerization or hydrolytic condensation, and heat treating the polymer at a high temperature in a non-oxidizing atmosphere, a metal carbide in microparticulate form having a high density and a sharp particle size distribution is produced in a very high yield relative to the starting material.

More particularly, when an organometallic compound, preferably having a polymerizable reactive group, sorbed to graphite is polymerized through condensation reaction or thermal polymerization into a thermally stabilized form, the problem that such a compound, when used as the starting material, will volatilize off during firing in a non-oxidizing gas stream is overcome. At the same time, the graphite (or carbon) having the organometallic compound sorbed thereto itself serves as a reducing agent and a carbon source for metal carbide. In this sense, the process is ideal for producing a particulate metal carbide.

According to the invention, there is provided a process for preparing a particulate metal carbide, comprising the steps of causing an organometallic compound to be sorbed to graphite; converting the organometallic compound to a substantially non-volatile polymer within the graphite through hydrolytic condensation, thermal polymerization or catalytic polymerization; and reacting the polymer with the graphite in a non-oxidizing atmosphere at a temperature of at least 1,300° C., thereby producing a metal carbide in particulate form.

Preferably, the organometallic compound has a polymerizable reactive group, typically a hydrolyzable group. Also preferably, the organometallic compound is a metal alkoxide, organometallic complex, metal soap or metal-containing organic compound. The organometallic compound may be a mixture of at least two organometallic compounds of different metals.

Also preferably, the graphite is expandable graphite.

The inventive process has been completed by paying attention to the fact that graphite, especially expandable graphite, can sorb an amount of several ten times greater than its own weight of oily liquid. An organometallic compound which is liquid or has been dissolved or dispersed in a solvent is sorbed in interstices of graphite and thermally stabilized, through thermal polymerization or hydrolytic condensation, into a substantially non-volatile polymer serving as a precursor. The precursor is then heat treated at a high temperature in a non-oxidizing or inert atmosphere, producing a single component or multi-component metal carbide in microparticulate form.

As used herein, the term “polymer” of an organometallic compound refers to a form of organometallic compound which has been fully crosslinked or consolidated and stabilized to be substantially non-volatile, by treatment such as hydrolytic condensation, thermal polymerization or catalytic polymerization.

Since the inventive process makes use of microscopic interstices in graphite, especially expandable graphite, as the reaction field, and at the same time, helps the graphite layer wall defining such interstices serve as a reducing agent, a particulate metal carbide of uniform quality and submicron size is obtainable without a need for extra steps other than the preparation of a precursor in air and the high-temperature heat treatment in a non-oxidizing or inert atmosphere.

The starting materials used in the inventive process are readily available, and most of them are inexpensive except those metals which are expensive by nature like tantalum and niobium.

According to the invention, particulate metal carbides finding a wide range of application as high-function engineering materials can be prepared in a simple, inexpensive manner.

### BRIEF DESCRIPTION OF THE DRAWINGS

FIG. 1 is a diagram showing XRD patterns of zirconium carbide products obtained by heat treatment at different temperatures of (a) 1400° C., (b) 1500° C., (c) 1600° C. or (d) 1700° C.

FIG. 2 is a diagram showing XRD patterns of zirconium carbide products in which the amount of zirconium tetrabutoxide varies among (a) 8.4 g, (b) 12.6 g, (c) 14.7 g and (d) 16.8 g.

FIG. 3 is a diagram showing XRD patterns of zirconium carbide products in which the temperature and time of heat treatment vary among (a) 1500° C./1 hour, (b) 1500° C./5 hours, (c) 1500° C./10 hours, and (d) 1600° C./1 hour.

FIG. 4 is a SEM photomicrograph of the product of heat treatment (d) in FIG. 3.

### DESCRIPTION OF THE PREFERRED EMBODIMENTS

According to the inventive process, a particulate metal carbide is prepared by causing an organometallic compound to be sorbed to graphite, converting the organometallic compound to a substantially non-volatile polymer within the graphite through hydrolytic condensation, thermal polymerization or catalytic polymerization, and reacting the polymer with the graphite in a non-oxidizing or inert atmosphere at a temperature of at least 1,300° C.

The organometallic compound used as the starting material in the inventive process is not critical as long as it has an ability of polycondensation and is liquid or dissolvable or dispersible in water or organic solvents. Preferred organometallic compounds have polymerizable reactive groups, typically hydrolyzable groups. Examples include metal alkoxides, organometallic complexes, metal soaps and metal-containing organic compounds.

Of the polymerizable reactive groups, hydrolyzable groups are preferred. Exemplary hydrolyzable groups are alkoxy groups, ketoxime groups, acyloxy groups, alkenyloxy groups, amino groups, amide groups and aminoxy groups. Specific examples include alkoxy groups such as methoxy, ethoxy, propoxy, isopropoxy, butoxy, isobutoxy, methoxyethoxy, and ethoxyethoxy; ketoxime groups such as dimethylketoxime, diethylketoxime and methylethylketoxime; acyloxy groups such as acetoxy and propionoxy; alkenyloxy groups such as vinyloxy, allyloxy, propenoxy and isopropenoxy; amino groups dimethylamino, diethylamino and methylethylamino; amide groups such as dimethylamide, diethylamide and methylethylamide; and aminoxy groups such as dimethylaminoxy, diethylaminoxy and methylethylaminoxy.

Examples of the organometallic compound include alkoxides of metals such as Zr, Ti, W, Cr, Mo, Ta and Nb, such as metal tetrabutoxides (e.g., zirconium tetrabutoxide Zr(OC₄H₉)₄ and titanium tetrabutoxide Ti(OCH₂CH₂CH₂CH₃)₄), metal tetraethoxides and metal tetrapropoxides; metal complexes such as metal acetylacetonates and metal oxynates; metal soaps such as metal acetates, metal methacrylates and metal 2-ethylhexanates; metal-containing organic compounds, typically metal salts of (higher) fatty acids having about 8 to about 30 carbon atoms, such as metal stearates, metal octylates, and metal naphthenates. They may be used alone or in admixture of any. When a mixture of two or more organometallic compounds is used, a combination of compatible compounds is preferred. A combination of metal alkoxides which are mutually miscible is favorable because it is easy to control a mixing ratio of such a multi-component system.

The solvent in which the organometallic compound is dissolved or dispersed is not particularly limited. Useful solvents are ordinary solvents and dispersing media including non-polar organic solvents such as toluene, xylene, hexane and heptane; and polar organic solvents, for example, esters such as methyl acetate and ethyl acetate, ketones such as acetone and methyl isobutyl ketone, and alcohols such as methanol, ethanol, propanol, isopropanol and butanol, as well as water. Since the solvent is added for the purpose of increasing the flow of the organometallic compound, the amount of the solvent used is preferably about 50 to 2,000 parts by weight, more preferably about 100 to 1,000 parts by weight per 100 parts by weight of the organometallic compound.

Examples of the graphite to which the liquid organometallic compound or the organometallic compound solution or dispersion is sorbed include expandable graphite, acetylene black, Ketjen Black, channel black, and activated carbon, with expandable graphite being most preferred.

The amount of the organometallic compound sorbed, which varies with a particular type of organometallic compound, is preferably 0.1 to 100 parts by weight, more preferably 1.0 to 50 parts by weight per 1.0 part by weight of the graphite. Too small a sorption amount may lead to a lower production yield relative to the graphite whereas too large a sorption amount may lead to under-carbonization due to carbon shortage.

The method and conditions of sorption are not particularly limited. For example, an organometallic compound can be sorbed to graphite by diluting the organometallic compound with an organic solvent, adding expandable graphite thereto, thoroughly mixing, and removing the solvent.

Once the organometallic compound is sorbed to graphite, the organometallic compound within the graphite is subjected to hydrolytic condensation or catalytic polymerization, whereby the organometallic compound is converted or thermally stabilized into a substantially non-volatile polymer. At this point, a choice of hydrolytic condensation, thermal polymerization or catalytic polymerization is made in accordance with the type of polymerizable reactive group on the organometallic compound.

Hydrolytic condensation is favorable when the organometallic compound has a hydrolyzable group as the reactive group. Hydrolytic condensation takes place once water is fed to the organometallic compound sorbed to graphite. This reaction is achieved by adopting reaction conditions for a particular organometallic compound. In the case of a metal alkoxide, for example, reaction preferably takes place at a temperature ranging from room temperature (23° C.) to 90° C. and a humidity of at least 80% RH.

Also, thermal polymerization or catalytic polymerization is achievable by adopting reaction conditions for a particular organometallic compound. Most often, treatment is preferably made at a temperature of about 80 to 200° C.

Once the organometallic compound is thermally stabilized by polymerizing it within graphite, it is heat treated at a high temperature in a non-oxidizing or inert gas stream, thereby producing a single component or multi-component metal carbide in particulate form.

The heat treatment is made in a non-oxidizing atmosphere such as vacuum, hydrogen, nitrogen and argon. The temperature of heat treatment is 1,300° C. or higher.

By the inventive process, a metal carbide is produced in particulate form having a particle size of about 10 to 10,000 nm, preferably about 50 to 5,000 nm, more preferably about 100 to 2,000 nm.

Referring to microparticulate zirconium carbide (ZrC) as a typical example, the invention is described in more detail.

An appropriate amount (8.4 to 16.8 g) of zirconium tetrabutoxide (Zr(OC₄H₉)₄) as a typical organozirconium compound is dissolved in 1-butanol (CH₃CH₂CH₂CH₂OH) to a total amount of 30 g. Expandable graphite (EG), 1 g, is added to the solution whereupon the zirconium tetrabutoxide solution is sorbed to graphite. It is transferred to a dish, which is placed in a desiccator which contains distilled water at the bottom. The desiccator is held in an oven heated above 40° C. for 1 to 5 hours, during which period hydrolytic condensation of alkoxide takes place. Subsequent drying in a vacuum oven at 60 to 150° C. gives a precursor. If the precursor is prepared similarly, but by drying only without hydrolytic condensation, the percent yield is reduced to about one-half. This suggests that the hydrolytic condensation step is essential to the process. Satisfactory results are obtained when the time of hydrolytic condensation under the above-described conditions is 2 to 3 hours.

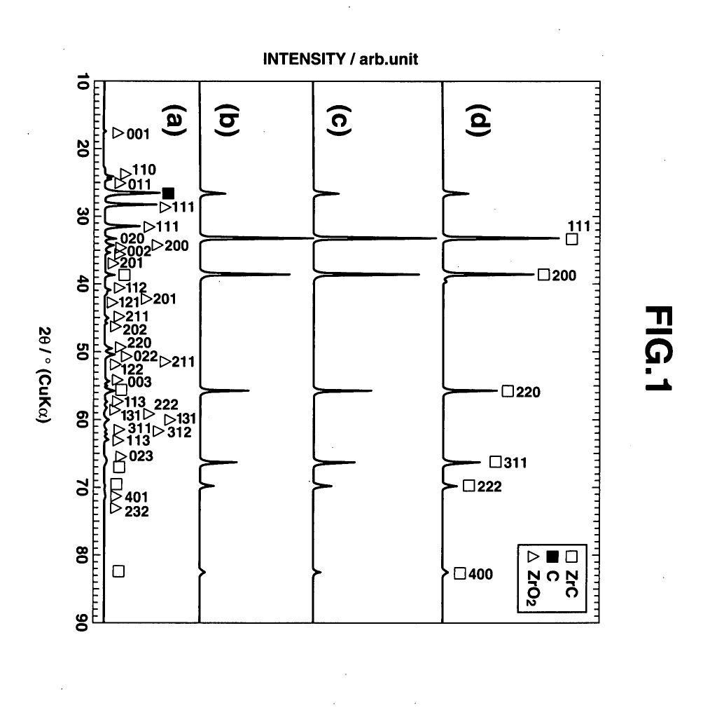

The precursor obtained by the above procedure when the amount of zirconium tetrabutoxide in the solution is 8.4 g is heat treated in an argon gas stream at a temperature of (a) 1400° C., (b) 1500° C., (c) 1600° C. or (d) 1700° C. for one hour, obtaining products which are characterized by the x-ray diffraction (XRD) patterns of FIG. 1. In heat treatment (a) at 1400° C., the majority of the product is zirconia (ZrO₂). In heat treatment (b) at 1500° C., the ZrO₂ content is reduced to a trace and the majority is zirconium carbide (ZrC). In heat treatments (c) and (d) at or above 1600° C., all peaks are assigned to zirconium carbide except the peak of C(002) from the residue of expandable graphite.

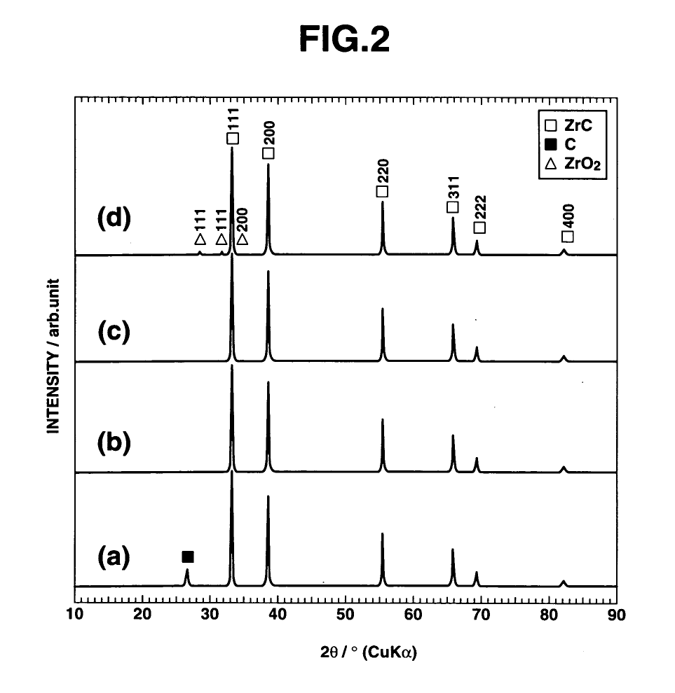

Since this composition is short of zirconium tetrabutoxide, precursors are prepared by changing the amount of zirconium tetrabutoxide from (a) 8.4 g to (b) 12.6 g, (c) 14.7 g and (d) 16.8 g. These precursors are heat treated at 1600° C. for one hour, obtaining products which are characterized by the XRD patterns of FIG. 2. The inclusion of at least 12.6 g of zirconium tetrabutoxide ensures the formation of substantially single phase zirconium carbide although a very weak peak of C(002) is left. Even if carbon is left, it can be removed simply by heating in air. However, if the amount of zirconium tetrabutoxide is increased too much, reduction becomes short. Formation of ZrO₂ starts at the amount of 16.8 g. For the zirconium tetrabutoxide of the purity used herein, an appropriate amount is 13 to 15 g per gram of expandable graphite.

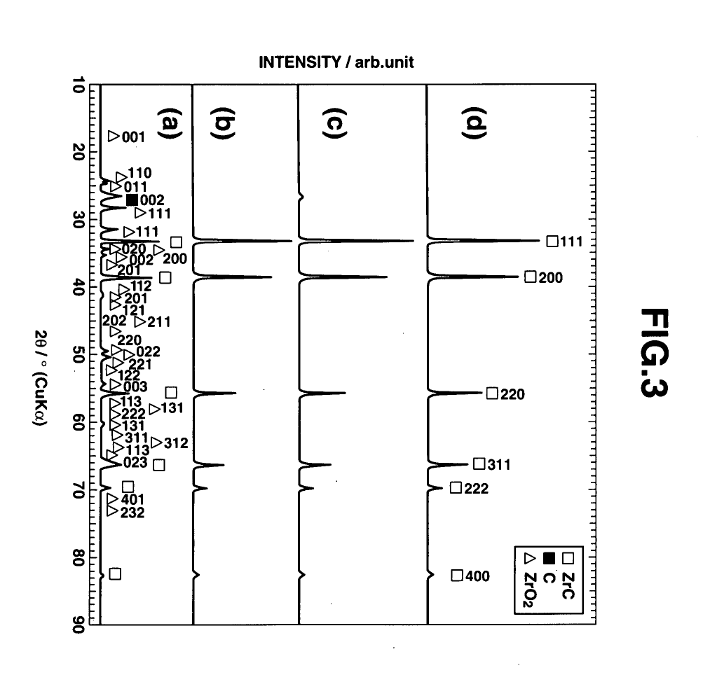

In the above experiment, the precursor obtained under optimum conditions (zirconium tetrabutoxide 14.7 g, hydrolysis time 2 hours) is used, and the temperature and time of heat treatment are changed to (a) 15000C/1 hour, (b) 1500° C./5 hours, (c) 1500° C./10 hours, and (d) 1600° C./1 hour, obtaining products which are characterized by the XRD patterns of FIG. 3. It is seen that the product of heat treatment at 1500° C. for 10 hours is substantially equivalent to the product of heat treatment at 1600° C. for 1 hour.

The yield of the product having an XRD pattern indicative of substantially single phase zirconium carbide is about 20% relative to the weight of its precursor and at least 85% when calculated as Zr. The product also has a zirconium content of 85.5% by weight. This zirconium content (average content) of 85.5% by weight in the product is slightly lower than 88.37% by weight for zirconium carbide of the stoichiometric composition. If it is assumed that all the impurity is ZrO₂, the molar ratio of ZrO₂ is in excess of 17%. This is unlikely from the XRD pattern. It is rather probable that unreacted expandable graphite is left, indicating that free carbon is contained in an amount of about 2.7% by weight. Also, if it is assumed that all the impurity is solid-solution oxygen, the impurity content is about 2.9% by weight. While it is presumed that an actual product contains both of them, this impurity content is substantially unchanged from commercially available products and at an acceptable level as long as properties are concerned.

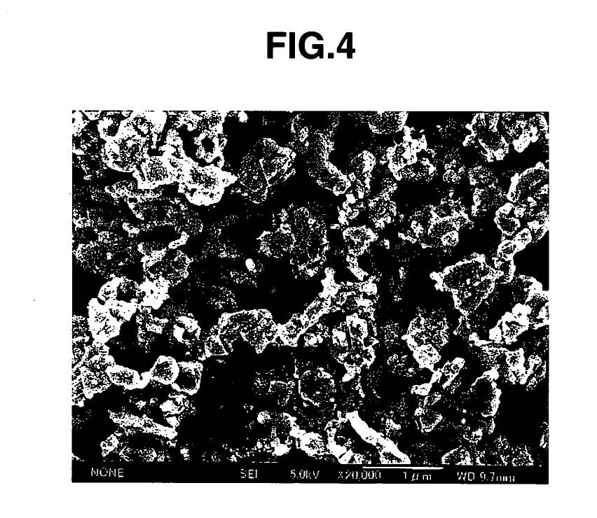

FIG. 4 is a photomicrograph under scanning electron microscope (SEM) of the product of heat treatment (d) at 1600° C. for 1 hour in FIG. 3. Fine particles having a size of the order of several hundred nanometers are seen although some are agglomerated.

For other metal carbides, adequate preparation processes are described.

1) Microparticulate Titanium Carbide (TiC):

It can be prepared by the same process as used for ZrC, using a combination of titanium tetrabutoxide (Ti(OCH₂CH₂CH₂CH₃) 4) with 1-butanol.

2) Microparticulate Tantalum Carbide (TaC), Niobium Carbide (NbC), etc.:

They can be prepared by the same process as used for ZrC.

3) Microparticulate Chromium Carbide (Cr₃C₂):

A chromium (III) acetylacetonate complex ([CH₃COCH═C(O—)CH₃]₃Cr) which is inexpensive and largely dissolvable in organic solvents such as toluene is sorbed to expandable graphite. This is dried and heat treated at a temperature near the complex's melting point of 210° C. for effecting decomposition and crosslinking/consolidation of the complex to form a non-volatile, thermally stable precursor. The precursor is then heat treated as described above.

4) Microparticulate Molybdenum Carbide (Mo₂C), Tungsten Carbide (WC), etc.:

A salt of a metal with a higher fatty acid, resin acid, naphthenic acid or the like (or metal soap) which is soluble in organic solvents is dissolved in an organic solvent, which is sorbed to expandable graphite. This is heated for removing the solvent and for subjecting the metal salt to thermal decomposition and crosslinking/consolidation to form a non-volatile, thermally stable precursor. The precursor is then heat treated as described above.

### EXAMPLE

Examples of the invention are given below by way of illustration and not by way of limitation.

### Example 1

12.6 g of zirconium tetrabutoxide (Zr(OC₄Hg)₄, commercially available, purity 85.5%) as a typical organozirconium compound was dissolved in 1-butanol (CH₃CH₂CH₂CH₂OH) to a total amount of 30 g. Expandable graphite (EG), 1 g, was added to the solution whereupon the zirconium tetrabutoxide solution was sorbed to graphite. It was transferred to a dish, which was placed in a desiccator which contained distilled water at the bottom. The desiccator was held in an oven at 60° C. for 2 hours. Subsequent drying in a vacuum oven at 150° C. gave a precursor. The precursor was then heat treated in an argon stream at 1600° C. for one hour, obtaining a product which was characterized by a pattern of zirconium carbide on x-ray diffractometry. The yield was 85.1% relative to zirconium.

### Example 2

As in Example 1, 14.7 g of zirconium tetrabutoxide (Zr(OC₄H₉)₄, commercially available, purity 85.5%) was sorbed to 1 g of expandable graphite (EG). It was placed in a desiccator which contained distilled water at the bottom. The desiccator was held in an oven at 60° C. for 3 hours. Subsequent drying in an air oven at 150° C. gave a precursor. The precursor was then heat treated in an argon stream at 1600° C. for one hour, obtaining a product which was characterized by an XRD pattern of zirconium carbide. The yield was 85.0% relative to zirconium.

### Example 3

The precursor obtained in Example 2 was heat treated in an argon stream at 1500° C. for 10 hours, obtaining a product which was characterized by the same XRD pattern of zirconium carbide as Example 2. The yield was 86.5% relative to zirconium.

### Comparative Example 1

12.6 g of zirconium tetrabutoxide (Zr(OC₄H₉)₄, commercially available, purity 85.5%) as a typical organozirconium compound was dissolved in toluene to a total amount of 30 g. Expandable graphite (EG), 1 g, was added to the solution whereupon the zirconium tetrabutoxide solution was sorbed to graphite. It was dried in a vacuum oven at 150° C. It was then heat treated in an argon stream at 1600° C. for one hour, obtaining a product which was characterized by an XRD pattern of zirconium carbide. The yield was 39.3% relative to zirconium.

### Comparative Example 2

As in Comparative Example 1, 14.7 g of zirconium tetrabutoxide (Zr(OC₄H₉)₄, commercially available, purity 85.5%) as a typical organozirconium compound was dissolved in hexane to a total amount of 30 g. Expandable graphite (EG), 1 g, was added to the solution whereupon the zirconium tetrabutoxide solution was sorbed to graphite. It was dried in an air oven (hot air circulation dryer) at 150° C. It was then heat treated in an argon stream at 1600° C. for one hour, obtaining a product which was characterized by an XRD pattern of zirconium carbide. The yield was 33.2% relative to zirconium.

TABLE 1

| | Zr(OC₄H₉)₄ | | | |
|---|---|---|---|---|
| | sorbed | Zr(OC₄H₉)₄ | Heat | |
| | to graphite | hydrolysis time | treatment | ZrC yield |
| | (g) | (hr) | conditions | (%) |
| Example 1 | 12.6 | 2 | 1600° C./1 hr | 85.1 |
| Example 2 | 14.7 | 3 | 1600° C./1 hr | 85.0 |
| Example 3 | 14.7 | 2 | 1500° C./10 hr | 86.5 |
| Comparative | 12.6 | 0 | 1600° C./1 hr | 39.3 |
| Example 1 | | | | |
| Comparative | 14.7 | 0 | 1600° C./1 hr | 33.2 |
| Example 2 | | | | |

The inventive process requires no extra steps, but high-temperature heat treatment in an inert gas, and can produce microparticulate metal carbides consistently at a low cost on an industrial scale. A single component or multi-component metal carbide in microparticulate form can be readily synthesized.

Japanese Patent Application No. 2003-192392 is incorporated herein by reference.

While preferred embodiments have been shown and described, various modifications and substitutions may be made thereto without departing from the spirit and scope of the invention. Accordingly, it is to be understood that the present invention has been described by way of illustrations and not limitation.

1. A process for preparing a particulate metal carbide, comprising the steps of:
causing an organometallic compound to be sorbed to graphite,
converting the organometallic compound to a substantially non-volatile polymer within the graphite through hydrolytic condensation, thermal polymerization or catalytic polymerization, and
reacting the polymer with the graphite in a non-oxidizing atmosphere at a temperature of at least 1,300° C., thereby producing a metal carbide in particulate form.

2. The process of claim 1, wherein the organometallic compound has a polymerizable reactive group.

3. The process of claim 2, wherein the polymerizable reactive group is a hydrolyzable group.

4. The process of claim 1, wherein the organometallic compound is a metal alkoxide, organometallic complex, metal soap or metal-containing organic compound.

5. The process of claim 1, wherein the organometallic compound is a mixture of at least two organometallic compounds of different metals.

6. The process of claim 1, wherein the graphite is expandable graphite.
